(19) United States
(12) Patent Application Publication
(10) Pub. No.: US 2012/0089823 A1
(43) Pub. Date: Apr. 12, 2012

(54) PROCESSING APPARATUS, COMPILING APPARATUS, AND DYNAMIC CONDITIONAL BRANCH PROCESSING METHOD

(75) Inventors: Tai-Song Jin, Seoul (KR); Dong-Hoon Yoo, Seoul (KR); Bernhard Egger, Seoul (KR); Won-Sub Kim, Anyang-si (KR)

(73) Assignee: Samsung Electronics Co., Ltd.,, Suwon-si (KR)

(21) Appl. No.: 13/092,829

(22) Filed: Apr. 22, 2011

(30) Foreign Application Priority Data
Oct. 7, 2010 (KR) 10-2010-0097957

(51) Int. Cl. G06F 9/38

(52) U.S. Cl. 712/239; 712/E09.062

(57) ABSTRACT

A technology for reducing pipeline a control hazard is provided. A conditional branch is processed through a conditional branch prediction, and a predetermined conditional branch prediction, which is determined as incorrect, may be modified through a following test for the conditional branch prediction, thereby reducing the pipeline control hazard quickly without additional hardware.

### CROSS-REFERENCE TO RELATED APPLICATION

This application claims the benefit under 35 U.S.C. §119(a) of Korean Patent Application No. 10-2010-0097957, filed on Oct. 7, 2010, the entire disclosure of which is incorporated herein by reference for all purposes.

### BACKGROUND

1. Field

The following description relates to a technique for processing a conditional branch instruction, and more particularly, to a dynamic conditional branch processing technology for reducing a pipeline control hazard.

2. Description of the Related Art

A pipeline is a parallel processing technique that enables high speed data processing by initiating execution of one instruction and then overlapping execution of following instructions, for example, in a coarse grained array (CGA).

An important factor that affects the performance of a processor in using a pipeline technique is a pipeline control hazard. The pipeline control hazard may degrade the processing performance of a processor.

When a branch instruction is fetched by a processor, a next memory address to be fetched is unknown before the branch instruction completes processing. Accordingly, the processor must wait until the next memory address to be fetched is known. This is referred to as a pipeline control hazard. This delay may degrade the efficiency of the processor.

### SUMMARY

In one general aspect, there is provided a processing apparatus for reducing a pipeline control hazard, the processing apparatus including a branch prediction code execution unit configured to predict whether to take a conditional branch by referring to hint information that is included in a branch prediction code for conditional branch prediction, when the branch prediction code for conditional branch prediction is fetched, and to proceed with branch or non-branch based on a result of the prediction, and a test code execution unit configured to evaluate a correctness of the conditional branch prediction performed by the branch prediction code execution unit, when a test code for conditional branch prediction test is fetched, and to update the hint information included in the branch prediction code based on a result of the evaluation.

The test code execution unit may record information indicating a successful prediction in the hint information included in the branch prediction code, if the prediction regarding whether to take a conditional branch is evaluated as correct.

The test code execution unit may record information indicating an unsuccessful prediction in the hint information included in the branch prediction code, if the prediction regarding whether to take a conditional branch is evaluated as incorrect.

The processing apparatus may fetch and execute a code scheduled behind the test code, after the test code is executed by the test code execution unit.

The processing apparatus may perform flush execution of branch or non branch performed by the branch prediction code execution unit, after the test code is executed by the test code execution unit.

If the branch prediction code execution unit proceeds with branch based on the result of the prediction, the branch prediction code execution unit may perform a branch at a branch time indicated by branch time information included in the branch prediction code to a target address indicated by target address information included in the branch prediction code.

The processing apparatus may fetch and execute a code of the target address after the branch performed.

If the branch prediction code execution unit proceeding with non-branch based on the result of the prediction, the processing apparatus may fetch and execute a next scheduled code.

In another aspect, there is provided a compiling apparatus including a code conversion unit configured to convert a conditional branch code into a branch prediction code for conditional branch prediction and a test code for a conditional branch prediction test, and a scheduling unit configured to schedule the test code at a final part of schedule information and schedule the branch prediction code at an arbitrary location ahead of the test code.

The branch prediction code may comprise target address information indicating a target address to branch, branch time information indicating a branch time, and hint information for a branch prediction.

The hint information may comprise information about a history regarding a success or a failure of prediction.

The branch prediction code may have a dependency with the test code.

In another aspect, there is provided a dynamic conditional branch processing method for reducing a pipeline control hazard which is executed in a processing apparatus, the processing method including executing a branch prediction code for conditional branch prediction in which whether to take a conditional branch is predicted based on hint information that is included in the branch prediction code, when the branch prediction code is fetched by the processing apparatus, performing a branch or non-branch based on a result of the prediction, executing a test code for conditional branch prediction test in which a correctness of the conditional branch prediction is evaluated, when the test code is fetched by the processing apparatus, and updating the hint information included in the branch prediction code based on a result of the evaluation.

The processing apparatus may record information indicating a success of prediction in the hint information included in the branch prediction code, if the prediction regarding whether to take a conditional branch is evaluated as correct.

The processing apparatus may record information indicating a failure of prediction in the hint information included in the branch prediction code, if the prediction regarding whether to take a conditional branch is evaluated as incorrect.

The processing apparatus may fetch and execute a code scheduled behind the test code, after the test code is executed by the processing apparatus.

The processing apparatus may perform a flush on execution of branch or non-branch that is performed in the executing of the branch prediction code, after the test code is executed by the processing apparatus.

If the processing apparatus proceeds with branch based on the result of the prediction, the processing apparatus may perform a branch at a branch time indicated by branch time information included in the branch prediction code to a target address indicated by target address information included in the branch prediction code.

The processing apparatus may fetch and execute a code of the target address after branch performed.

If the processing apparatus proceeds with non-branch based on the result of the prediction, the processing apparatus may fetch and execute a next scheduled code.

In another aspect, there is provided a processing apparatus including a compiler configured to convert conditional branch code into branch prediction code for conditional branch prediction, and a branch prediction unit configured to predict whether to take a conditional branch based on hint information that is included in the branch prediction code, and to proceed with branch or non-branch based on the result of the prediction.

The compiler may further convert the conditional branch code into test code for a conditional branch prediction test, and the processing apparatus may further comprise a test code execution unit configured to determine if the conditional branch prediction made by the branch prediction unit is correct based on the test code, and configured to update the hint information included in the branch prediction code based upon the result of the determination.

In response to the test code execution unit determining the conditional branch prediction made by the processor is correct, the processing apparatus may fetch and execute the code scheduled to be executed after the test code.

In response to the test code execution unit determining the conditional branch prediction made by the processor is incorrect, the processing apparatus may perform a flush of codes of the conditional branch or non-branch executed by the branch prediction unit to modify erroneously predicted code.

Other features and aspects may be apparent from the following detailed description, the drawings, and the claims.

### BRIEF DESCRIPTION OF THE DRAWINGS

FIG. 1 is a diagram illustrating an example of a computing apparatus.

FIG. 2 is a diagram illustrating an example of a processing apparatus for reducing a pipeline control hazard.

FIG. 3 is a diagram illustrating an example of codes of basic blocks executed in a processor for reducing a pipeline control hazard.

FIG. 4 is a diagram illustrating an example of pipeline stages of the basic block codes shown in FIG. 3.

FIG. 5 is a diagram illustrating an example of a compiling apparatus for reducing a pipeline control hazard.

FIG. 6 is a diagram illustrating an example of codes of basic blocks to be scheduled by the compiling apparatus shown in FIG. 5.

FIG. 7 is a flowchart illustrating an example of a method in which a conditional branch code is converted and scheduled in a compiling apparatus.

FIGS. 8A and 8B are flowcharts illustrating an example of a dynamic branch processing method for reducing a pipeline control hazard.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

In various aspects, while processing a conditional branch code, it is possible to determine whether a conditional branch is taken or not through a branch prediction. As a result, the pipeline control hazard may be reduced and the performance of a processing apparatus may be improved.

For example, a conditional branch may be processed with high speed through a conditional branch prediction, and a conditional branch prediction which is determined as incorrect may be modified through a test for a conditional branch prediction. Accordingly, the pipeline control hazard may be reduced in a rapid manner without additional hardware.

In various aspects, the branch prediction may be implemented in a static branch prediction scheme or a dynamic branch prediction scheme based on whether the branch prediction is performed by a compiling apparatus or a processing apparatus.

For example, the static branch prediction scheme may be implemented when a compiling apparatus performs a branch prediction and a processing apparatus modifies a branch prediction, which may be determined through a test for branch prediction.

As another example, the dynamic branch prediction scheme may be implemented when a compiling apparatus performs a branch prediction and a modification on a branch prediction, which may be determined through a test for branch prediction.

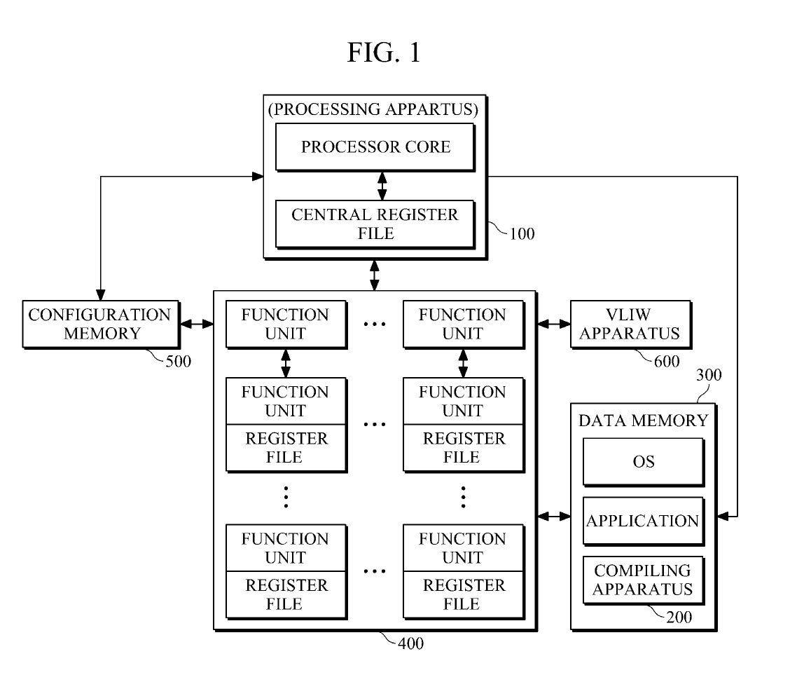

FIG. 1 illustrates an example of a computing apparatus.

Referring to FIG. 1, the computing apparatus includes a processing apparatus 100, a compiling apparatus 200, a data memory 300, a reconfigurable apparatus 400, a configuration memory 500, and a very long instruction word (VLIW) apparatus 600.

In response to an application written in a high level language being executed by the computing apparatus, the compiling apparatus 200 may compile a source code of the application. For example, the application may be stored in the data memory 300.

The compiling apparatus 200 may schedule the compiled instructions to reconfigure a data path of the processing elements of the reconfigurable apparatus 400, and may store reconfiguration information in the configuration memory 500.

The processing apparatus 100 may process loops that have a large amount of data operations quickly through the processing elements of the reconfigurable apparatus 400. As an example, the processing elements may be connected based on the reconfiguration information stored in the configuration memory 500. The processing apparatus 100 may process a control part that has a smaller amount of data operations through the VLIW apparatus 600.

In this example, the control part may have a small sized basic block (BB) and a simple data flow. The VLIW apparatus 600 may detect instructions that are concurrently executable, rearrange the instructions in an instruction code, and execute the instructions. In FIG. 1, a central register file may store a result value calculated in the reconfigurable apparatus 400 and a result value of the processing apparatus 100 during processing.

Before a dynamic branch prediction is performed by the processing apparatus 100, the compiling apparatus 200 may convert a conditional branch code into a branch prediction code for conditional branch prediction and a test code for a conditional branch prediction test.

The branch prediction code may include, for example, target address information indicating a branch target address, branch time information indicating branch time, and hint information for branch prediction. The compiling apparatus 200 may perform scheduling such that the test code and the branch prediction code are disposed in a final part of the schedule information and at an arbitrary location ahead of the test code, respectively.

After the test code and the branch prediction code are disposed at the final part of the schedule information and at an arbitrary location ahead the test code, respectively, the processing apparatus 100 may perform a dynamic branch prediction and a test for dynamic branch prediction.

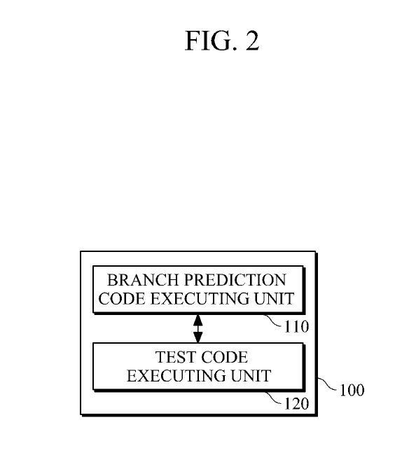

FIG. 2 illustrates an example of a processing apparatus for reducing a pipeline control hazard.

Referring to FIG. 2, the processing apparatus 100 includes a branch prediction code execution unit 110 and a test code execution unit 120.

The branch prediction code execution unit 110 may predict whether to take a conditional branch by referring to hint information for branch prediction that is included in a branch prediction code. For example, in response to the branch prediction code for conditional branch prediction being fetched, the branch prediction code execution unit 110 may predict whether to take a conditional branch. The branch prediction code execution unit 110 may proceed with branch (referred to as ‘taken’) or non-branch (referred to as ‘not taken’) based on a result of the prediction.

For example, the hint information may represent information that includes a history regarding a success or a failure of predictions, and may be updated by the test code execution unit 120. The branch prediction code execution unit 110 may predict whether to proceed with branch or non-branch by referring to the history regarding a success or a failure of prediction.

In proceeding with branch based on the result of the prediction, the branch prediction code execution unit 110 may proceed with branch at a branch time indicated by branch time information included in the branch prediction code to a target address indicated by target address information include in the branch prediction code. After branching to the target address, the processing apparatus 100 may fetch and execute a code of the target address.

As another example, in proceeding with non-branch based on the result of the prediction, the branch prediction code execution unit 110 may fetch and execute a next scheduled code.

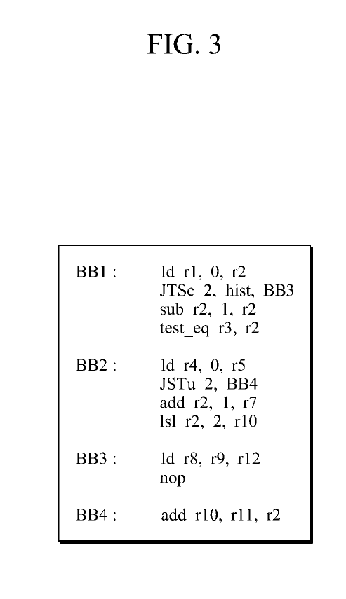

FIG. 3 illustrates an example of codes of basic blocks executed in a processor for reducing a pipeline control hazard.

Referring to FIG. 3, ‘JTSc’ of basic block BB1 represents a branch prediction code and ‘2’ of basic block BB1 represents branch time information indicating a branch time. In this example, it is instructed that a branch is made after 2 cycles. In FIG. 3, ‘hist’ of basic block BB1 represents hint information for branch prediction and ‘BB3’ of basic block BB1 is target address information indicating target address. In this example, it is instructed that a branch is made to BB3.

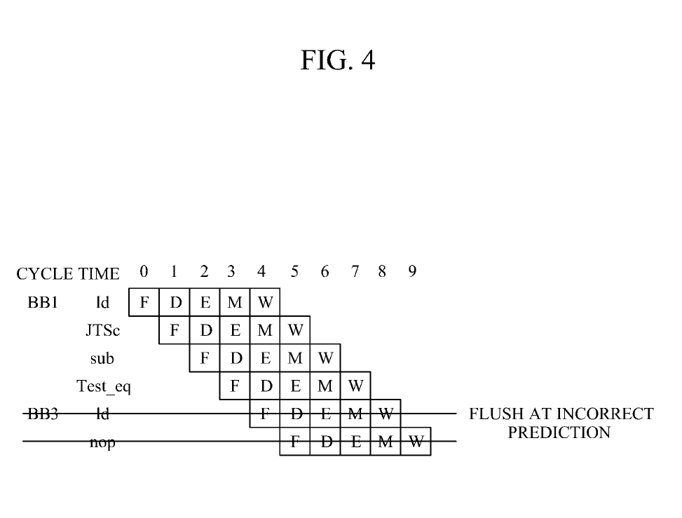

FIG. 4 illustrates an example of pipeline stages of the basic block codes shown in FIG. 3.

Referring to FIG. 4, when processing a code (instructions) in the processing apparatus 100, a code is fetched, the fetched code is decoded, the decoded code is executed, and the result of execution is written in a memory.

As shown in FIG. 4, after the processing apparatus 100 processes a ‘ld’ code of the basic block BB1, and if a branch prediction code ‘JTSc’ is fetched, the processing apparatus 100 may predict whether to take a conditional branch by referring to hint information ‘hist’ for branch prediction that is included in the branch prediction code ‘JTSc’ by operating the branch prediction code execution unit 100 and may proceed with branch or non-branch based on the result of the prediction.

For example, if a branch is predicted, the branch prediction code execution unit 110 may perform a branch to the basic block ‘BB3’ after ‘2’ cycles and the processing apparatus 100 may fetch an execute an ‘ld’ code of the basic block ‘BB3’.

As another example, if a non-branch is predicted, the processing apparatus 100 may fetch and execute a ‘sub’ code scheduled behind the branch prediction code ‘JTSc’ of the basic block ‘BB1’.

As described in various aspects, the processing apparatus 100 may quickly process a conditional branch by use of hint information for branch prediction included in the branch prediction code obtained when the branch prediction code is fetched.

The test code execution unit 120 may evaluate a correctness of the conditional branch prediction that is performed by the branch prediction code execution unit 110. For example, in response to a test code for conditional branch prediction test being fetched, the test code execution unit 120 may evaluate the correctness of the conditional branch prediction and update the hint information included in the branch prediction code based on the result of evaluation.

The test code execution unit 120 may record information indicating a success of prediction in the hint information included in the branch prediction code, if the prediction regarding whether to take a conditional branch is evaluated as correct. After processing the test code by the test code execution unit 120, the processing apparatus 100 may fetch and execute a code scheduled behind the test code.

The test code execution unit 120 may record information indicating a failure of prediction in the hint information included in the branch prediction code, if the prediction regarding whether to take a conditional branch is evaluated as incorrect. After processing the test code by the test code execution unit 120, the processing apparatus 100 may perform a flush on execution of branch or non-branch performed by the branch prediction code execution unit 110, thereby modifying erroneously predicted code.

The test code for conditional branch prediction test may evaluate a processing after a branch prediction code has been performed. Accordingly, the test code has a dependency with the branch prediction code. Meanwhile, the branch prediction code does not have a dependency on other codes except for the test code. Accordingly, the branch prediction code may be disposed at an arbitrary location that is ahead of the test code.

The branch prediction code may include target address information indicating a target address. The earlier the target address is acquired, the earlier the reduced pipe control hazard may be provided. For example, the branch prediction code may be located at or near the front of the schedule information.

As another example, if codes having a non dependency with the branch prediction code are primarily scheduled and then the branch prediction codes are scheduled in the remaining slots, delay slots do not need to be filled, and the processing performance may be improved.

As another example, the test code may be disposed at a final part of the schedule information such that a code of the next basic block is fetched without delay after the test code is processed. In this example, the delay slot does not need to be used after the test code or the use of delay slot is minimized, thereby reducing the pipeline control hazard.

As shown in FIG. 3, ‘test_eq’ of the basic block ‘BB1’ represents a test code and the test code execution unit 120 determines the correctness of the conditional branch prediction performed by the branch prediction code execution unit 110 by comparing a register variable ‘r2’ with a register variable ‘r3’.

As shown in FIG. 4, if the register variable ‘r2’ of the test code ‘test_eq’ of the basic block ‘BB1' is different from the register variable ‘r3 of the test code ‘test_eq’, the test code execution unit 120 may determine that the conditional branch prediction by the branch prediction code execution unit 110 is not correct. The test code execution unit 120 may update the hint information included in the branch prediction code and performs flush on the basic block ‘BB3’ codes including ‘ld’ code and ‘nop’ that are executed by the branch prediction code execution unit 110, thereby modifying erroneously predicted code predicted by the branch prediction code execution unit 110.

In this example, a conditional branch may be more rapidly performed through a conditional branch prediction, and a conditional branch prediction, which is determined as incorrect, may be modified through a following test for the branch prediction. Accordingly, the pipeline control hazard may be quickly reduced without additional hardware and the performance of the processing apparatus may be improved.

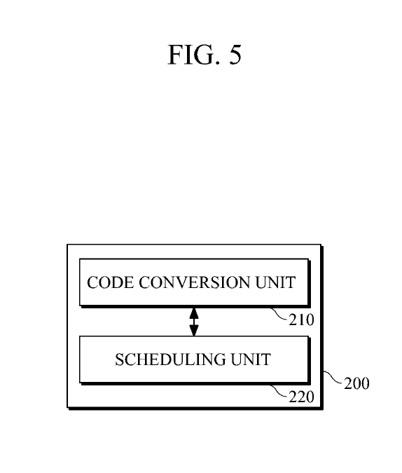

FIG. 5 illustrates an example of a compiling apparatus for reducing a pipeline control hazard. As an example, an application written in a high level language may be executed, and the compiling apparatus 200 may compile source code of the application.

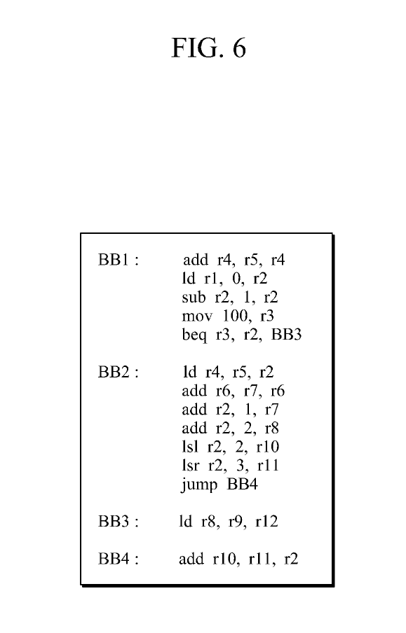

FIG. 6 illustrates an example of codes of basic blocks to be scheduled by the compiling apparatus shown in FIG. 5.

The compiling apparatus 200 may schedule the compiled instructions to reconfigure a data path of processing elements of the reconfigurable apparatus 400 and may store reconfiguration information in the configuration memory 500.

Referring to the example shown in FIG. 5, the compiling apparatus 200 includes a code conversion unit 210 and a scheduling unit 220 for reducing a pipeline control hazard.

The code conversion unit 210 may convert a conditional branch code into a branch prediction code for conditional branch prediction and a test code for a conditional branch prediction test. For example, the branch prediction code may include target address information indicating a target address, branch time information indicating branch time, and hint information for branch prediction. The hint information may represent information recording a history about a success or a failure of prediction.

The scheduling unit 220 may dispose the test code and the branch prediction code at a final part of schedule information and at an arbitrary location ahead of the test code, respectively.

The test code for conditional branch prediction test may evaluate a processing result after a branch prediction code has been performed. Accordingly, the test code has a dependency with the branch prediction code. Meanwhile, the branch prediction code does not have a dependency on other codes except for the test code. Accordingly, the branch prediction code may be disposed at an arbitrary location ahead of the test code.

The branch prediction code includes target address information indicating a target address. The earlier the target address is acquired, the earlier the reduced pipe control hazard may be provided. Accordingly, the scheduling unit 220 may dispose the branch prediction code at a front location of schedule information.

Meanwhile, if the scheduling unit 220 primarily schedules codes having a non dependency with the branch prediction code and then schedules branch prediction codes in remaining slots, delay slots do not need to be filled, and the processing performance may be improved.

Meanwhile, the scheduling unit 220 may dispose the test code at a final part of the schedule information such that a code of the next basic block is fetched without delay after the test code is processed. In this example, the delay slot does do not need to be used after the test code or the use of delay slot may be minimized, thereby reducing the pipeline control hazard.

For example, basic block codes shown in FIG. 6 may be converted by the compiling apparatus 200, the converted codes may be scheduled as shown in FIG. 3, and the processing apparatus 100 may process the scheduled instructions such that a conditional branch is processed with high speed through the branch prediction code, and may perform a test for the conditional branch prediction through the test code. In this example, a conditional branch prediction that is evaluated as incorrect may be modified, so the pipeline control hazard may be quickly reduced without additional hardware.

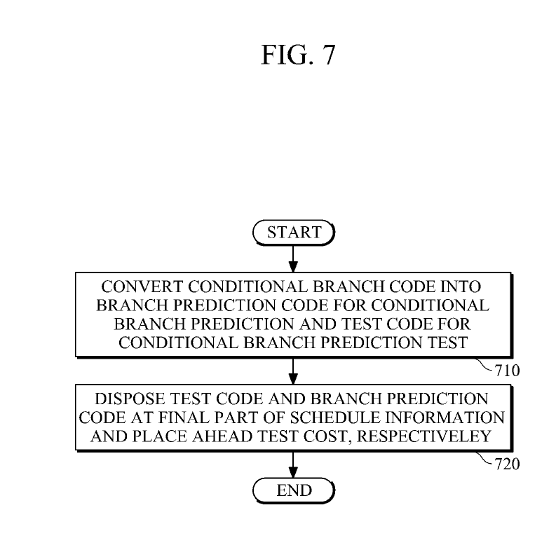

FIG. 7 illustrates an example of a method in which a conditional branch code is converted and scheduled in a compiling apparatus.

Referring to FIG. 7, an example of the compiling apparatus is described in which the compiling apparatus converts a conditional branch code and performs scheduling before performing a dynamic conditional branch processing for reducing a pipeline control hazard.

As an application written in a high level language is executed, the compiling apparatus 200 may compile source code of the application, thereby generating basic block codes in a complied form as shown in FIG. 6. In this example, each basic block includes at least one conditional branch code.

The compiling apparatus 200 converts a conditional branch code into a branch prediction code for conditional branch prediction and a test code for a conditional branch prediction test, in 710. For example, the branch prediction code may include target address information indicating a target address, branch time information indicating branch time, and hint information for branch prediction. The hint information may represent information that includes a history about a success or a failure of prediction.

The compiling apparatus 200 may perform scheduling such that the test code and the branch prediction code are disposed at a final part of schedule information and at an arbitrary location that is ahead of the test code, respectively, thereby generating basic block codes in a scheduling form, in 720. For example, the compiling apparatus 200 may generate the basic block codes in scheduling form as shown in FIG. 3.

The test code for conditional branch prediction test may evaluate a processing after a branch prediction code has been performed. Accordingly, the test code has a dependency with the branch prediction code. Meanwhile, the branch prediction code does not have a dependency other codes except for the test code. Accordingly, the branch prediction code may be disposed at an arbitrary location that is ahead of the test code.

For example, the branch prediction code may include target address information indicating a target address. The earlier the target address is acquired, the earlier the reduced pipe control hazard may be provided. Accordingly, the branch prediction code may be disposed at a front location of schedule information.

As another example, if codes having a non dependency with the branch prediction code are primarily scheduled and then branch prediction codes are scheduled in remaining slots, delay slots do not need to be provided, and the processing performance may be improved.

As another example, the test code may be disposed at a final part of the schedule information such that a code of the next basic block is fetched without delay after the test code is processed. In this example, the delay slot does not need to be used after the test code or the use of delay slot may be minimized, thereby reducing the pipeline control hazard.

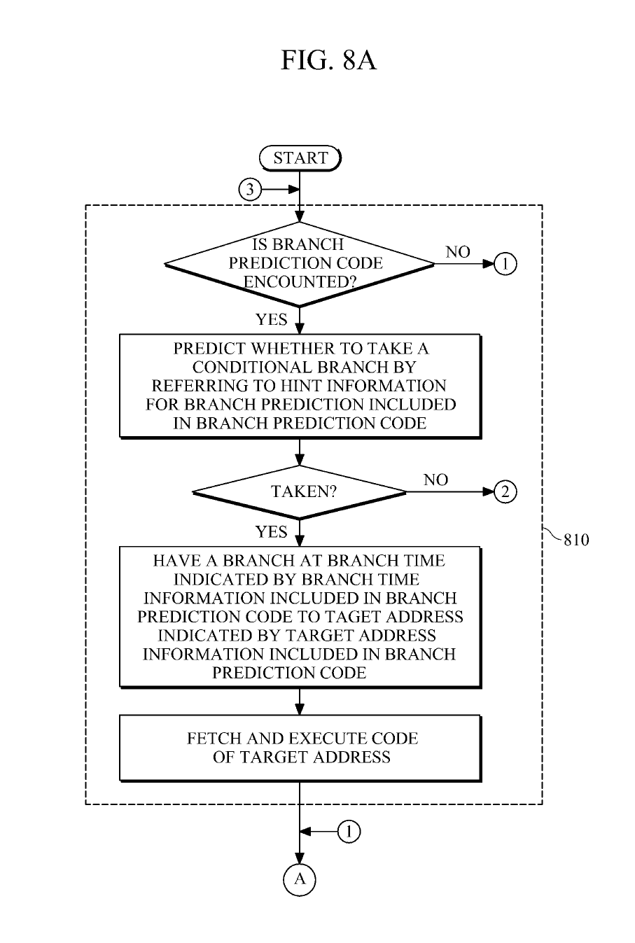

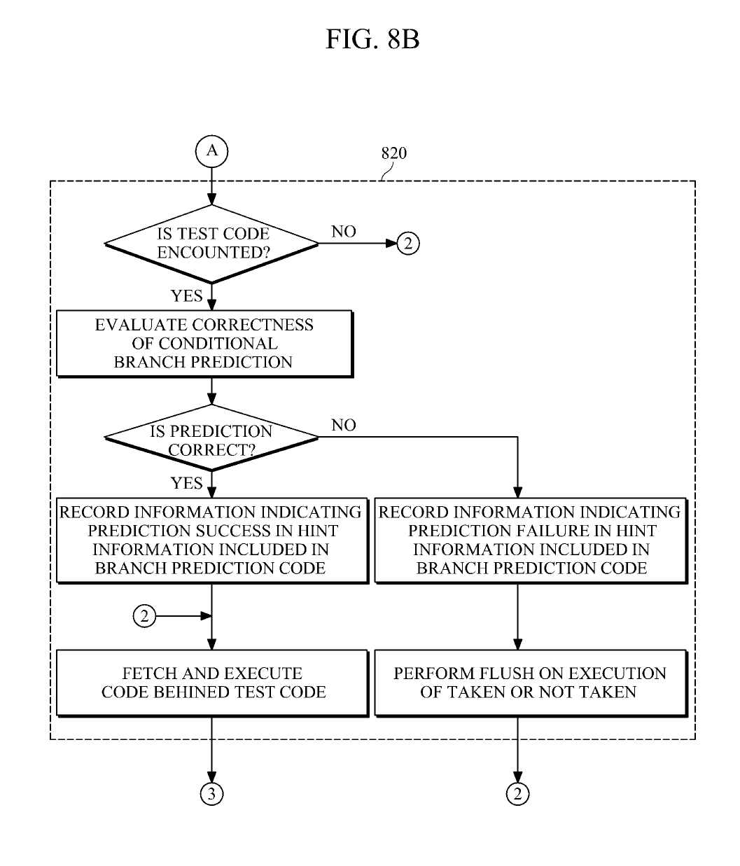

FIGS. 8A and 8B illustrate an example of a dynamic branch processing method for reducing a pipeline control hazard.

Referring to FIGS. 8A and 8B, a conditional branch processing method of a processing apparatus for reducing a pipeline control hazard is described.

Basic block codes scheduled as shown in FIG. 3 may be generated by the compiling apparatus 200. For example, at least one of the scheduled basic blocks may include a branch prediction code, which includes target address information indicating a target address, branch time information indicating branch time, and hint information for branch prediction. The at least one scheduled basic block may also include a test code for conditional branch prediction test. The processing apparatus 100 may execute the branch prediction code and the test code.

The dynamic conditional branch processing method includes executing a branch prediction code, in 810. In 810, the processing apparatus 100 predicts whether to take a conditional branch by referring to hint information that is included in the branch prediction code when the branch prediction code is fetched by the processing apparatus, and then proceeds with branch or non-branch based on the result of the prediction.

In proceeding with branch based on the result of the prediction of 810, the processing apparatus 100 performs a branch at a branch time indicated by branch time information included in the branch prediction code to a target address indicated by target address information include in the branch prediction code.

In proceeding with branch based on the result of the prediction of operation 810, the processing apparatus 100 fetches and executes a code of the target address. In proceeding with non-branch according to the result of the prediction of operation 810, the processing apparatus 100 fetches and executes a code scheduled behind the test code.

In this example, when the branch prediction code is fetched, the processing apparatus 100 may process a conditional branch with high speed based on the hint information for branch prediction that is included in the branch prediction code.

The dynamic conditional branch processing method includes executing a test code, in 820. In 820, the processing apparatus 100 evaluates a correctness of the conditional branch prediction in response to the test code for conditional branch prediction being fetched, and updates the hint information included in the branch prediction code according to a result of the evaluation.

If the prediction is evaluated as correct in 820, the processing apparatus 100 records information indicating a success of prediction in the hint information included in the branch prediction code. In this example, the processing apparatus 100 fetches and executes a code scheduled behind the test code after executing the test code.

If the prediction is evaluated as incorrect in 820, the processing apparatus 100 records information indicating a failure of prediction in the hint information included in the branch prediction code. In this example, the processing apparatus 100 executes the test code and then performs flush on the execution of branch or non-branch performed in 810.

In this example, a conditional branch is rapidly processed through a conditional branch prediction, and a conditional branch prediction, which is determined as incorrect, is modified through a following test for the branch prediction. Accordingly, the pipeline control hazard is reduced with high speed without additional hardware.

In various aspects, there is provided a processing apparatus, compiling apparatus, and dynamic conditional branching method capable of reducing pipeline control hazard to improve the performance of a processor.

For example, the processing apparatus may predict whether to take a conditional branch by referring to hint information for branch prediction that is included in a branch prediction code for conditional branch prediction when the branch prediction code for conditional branch prediction is fetched. Thereafter, the processing apparatus proceeds with branch or non-branch according to a result of the prediction.

As another example, the compiling apparatus may convert a conditional branch code into a branch prediction code for conditional branch prediction and a test code for a conditional branch prediction test. Thereafter, the compiling apparatus may dispose the test code and the branch prediction code at a final part of schedule information and at an arbitrary location ahead the test code, respectively.

Various aspects described herein are directed towards a processing apparatus. As an example, the processing apparatus may comprise a compiler that may convert conditional branch code into branch prediction code for conditional branch prediction. The processing apparatus may also comprise a branch prediction unit that may predict whether to take a conditional branch based on hint information that is included in the branch prediction code, and may proceed with branch or non-branch based on the result of the prediction.

In certain aspects, the compiler may further convert the conditional branch code into test code for a conditional branch prediction test. The processing apparatus may further comprise a test code execution unit that may determine if the conditional branch prediction made by the branch prediction unit is correct based on the test code, and may update the hint information included in the branch prediction code based upon the result of the determination.

In response to the test code execution unit determining the conditional branch prediction made by the processor is correct, the processing apparatus may fetch and execute the code scheduled to be executed after the test code.

As another example, in response to the test code execution unit determining the conditional branch prediction made by the processor is incorrect, the processing apparatus may perform a flush of codes of the conditional branch or non-branch executed by the branch prediction unit to modify erroneously predicted code.

As described above, a conditional branch is rapidly processed through a conditional branch prediction, and a predetermined conditional branch prediction, which is determined as incorrect, may be modified through a following test for the conditional branch prediction. Accordingly, the pipeline control hazard is reduced with high speed without additional hardware.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

The computing apparatus, the processing apparatus, and/or the compiling apparatus described herein may be included in a terminal, such as a mobile terminal. As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A processing apparatus for reducing a pipeline control hazard, the processing apparatus comprising:
a branch prediction code execution unit configured to predict whether to take a conditional branch by referring to hint information that is included in a branch prediction code for conditional branch prediction, when the branch prediction code for conditional branch prediction is fetched, and to proceed with branch or non-branch based on a result of the prediction; and
a test code execution unit configured to evaluate a correctness of the conditional branch prediction performed by the branch prediction code execution unit, when a test code for conditional branch prediction test is fetched, and to update the hint information included in the branch prediction code based on a result of the evaluation.

2. The processing apparatus of claim 1, wherein the test code execution unit records information indicating a successful prediction in the hint information included in the branch prediction code, if the prediction regarding whether to take a conditional branch is evaluated as correct.

3. The processing apparatus of claim 1, wherein the test code execution unit records information indicating an unsuccessful prediction in the hint information included in the branch prediction code, if the prediction regarding whether to take a conditional branch is evaluated as incorrect.

4. The processing apparatus of claim 2, wherein the processing apparatus fetches and executes a code scheduled behind the test code, after the test code is executed by the test code execution unit.

5. The processing apparatus of claim 3, wherein the processing apparatus performs flush execution of branch or non branch performed by the branch prediction code execution unit, after the test code is executed by the test code execution unit.

6. The processing apparatus of claim 1, wherein, if the branch prediction code execution unit proceeds with branch based on the result of the prediction, the branch prediction code execution unit performs a branch at a branch time indicated by branch time information included in the branch prediction code to a target address indicated by target address information included in the branch prediction code.

7. The processing apparatus of claim 6, wherein the processing apparatus fetches and executes a code of the target address after the branch performed.

8. The processing apparatus of claim 1, wherein, if the branch prediction code execution unit proceeding with non-branch based on the result of the prediction, the processing apparatus fetches and executes a next scheduled code.

9. A compiling apparatus comprising:
a code conversion unit configured to convert a conditional branch code into a branch prediction code for conditional branch prediction and a test code for a conditional branch prediction test; and
a scheduling unit configured to schedule the test code at a final part of schedule information and schedule the branch prediction code at an arbitrary location ahead of the test code.

10. The compiling apparatus of claim 9, wherein the branch prediction code comprises target address information indicating a target address to branch, branch time information indicating a branch time, and hint information for a branch prediction.

11. The compiling apparatus of claim 10, wherein the hint information comprises information about a history regarding a success or a failure of prediction.

12. The compiling apparatus of claim 9, wherein the branch prediction code has a dependency with the test code.

13. A dynamic conditional branch processing method for reducing a pipeline control hazard which is executed in a processing apparatus, the processing method comprising:
executing a branch prediction code for conditional branch prediction in which whether to take a conditional branch is predicted based on hint information that is included in the branch prediction code, when the branch prediction code is fetched by the processing apparatus;
performing a branch or non-branch based on a result of the prediction;
executing a test code for conditional branch prediction test in which a correctness of the conditional branch prediction is evaluated, when the test code is fetched by the processing apparatus; and
updating the hint information included in the branch prediction code based on a result of the evaluation.

14. The processing method of claim 13, wherein the processing apparatus records information indicating a success of prediction in the hint information included in the branch prediction code, if the prediction regarding whether to take a conditional branch is evaluated as correct.

15. The processing method of claim 13, wherein the processing apparatus records information indicating a failure of prediction in the hint information included in the branch prediction code, if the prediction regarding whether to take a conditional branch is evaluated as incorrect.

16. The processing method of claim 14, wherein the processing apparatus fetches and executes a code scheduled behind the test code, after the test code is executed by the processing apparatus.

17. The processing method of claim 15, wherein the processing apparatus performs a flush on execution of branch or non-branch that is performed in the executing of the branch prediction code, after the test code is executed by the processing apparatus.

18. The processing method of claim 13, wherein, if the processing apparatus proceeds with branch based on the result of the prediction, the processing apparatus performs a branch at a branch time indicated by branch time information included in the branch prediction code to a target address indicated by target address information included in the branch prediction code.

19. The processing method of claim 18, wherein the processing apparatus fetches and executes a code of the target address after branch performed.

20. The processing method of claim 13, wherein, if the processing apparatus proceeds with non-branch based on the result of the prediction, the processing apparatus fetches and executes a next scheduled code.
